(19) United States
(12) Patent Application Publication
(10) Pub. No.: US 2006/0234123 A1
(43) Pub. Date: Oct. 19, 2006

(54) Lithium Rechargeable Battery

(75) Inventors: Alain VALLEE, Varennes (CA); Patrick Leblanc, Boucherville (CA); Martin Beauparlant, Montreal (CA)

Correspondence Address: OSLER, HOSKIN & HARCOURT, LLP (AVESTOR), 1000 DE LA GAUCHETIERE STREET WEST, SUITE 2100, MONTREAL, QC, H3B-4W5, CA

(73) Assignee: Avestor Limited Partnership, Boucherville (CA)

(21) Appl. No.: 11/279,690

(22) Filed: Apr. 13, 2006

Related U.S. Application Data
(60) Provisional application No. 60/671,486, filed on Apr. 15, 2005.

(51) Int. Cl. H01M 4/48; H01M 4/58

(52) U.S. Cl. 429/231.1; 429/221; 429/231.5

(57) ABSTRACT

A lithium rechargeable battery comprising a series of electrochemical cells each having an Li₄Ti₅O₁₂ based anode, an LiFePO₄ based cathode, an electrolyte and a separator between the anode from the cathode, wherein each electrochemical cell comprises an excess of LiFePO₄ based cathode relative to the Li₄Ti₅O₁₂ based anode to prevent permanently damaging the electrochemical cell in an over-discharge.

### CROSS REFERENCES TO RELATED APPLICATIONS

The present Utility Patent Application claims priority on U.S. Provisional Application No. 60/671,486 filed Apr. 15, 2005, the content of which is incorporated herein by reference.

### FIELD OF THE INVENTION

The present invention relates generally to Lithium rechargeable batteries and, more particularly, to Lithium rechargeable batteries optimized for large format batteries and long cycle life.

### BACKGROUND OF THE INVENTION

Lithium batteries comprising Lithium Titanium Oxide, Li₄Ti₅O₁₂, as anode or negative electrode material and Lithium Iron Phosphate, LiFePO₄, as cathode (or positive electrode) material have recently emerged as a promising candidate for Electric or Hybrid vehicles as well as stationary applications and power tools. This specific couple of electrode materials provides long cycle stability, environment compatibility (low toxicity) and low cost with appreciable capacity values for a broad range of discharge rates.

Li₄Ti₅O₁₂ has a spinal-type structure where the electrochemical process involves the reversible insertion of lithium ions occurring at a stable voltage of approximately 1.55V vs. Li+/Li at 25° C. LiFePO₄ has an olivine structure where the electrochemical process involves the reversible insertion-extraction of lithium ions also occurring at a flat voltage plateau of about 3.45V vs. Li+/Li at 25° C. Because the voltage difference between the anode and cathode material operate within the stability window of most electrolytes, the electrolyte is not likely to react with the anode or cathode active materials and the battery is expected to be safe and to have an inherently high cycling life.

One of the remaining obstacles to the longevity of this electrode combination is the potential degradation of the LiFePO₄ cathode material under condition of over-discharge that may occur if the battery is not equipped with an electronic protection that shuts down the battery when an over-discharge condition occurs. Even equipped with an electronic shut down protection, a battery which comprises a plurality of cells connected in series or parallel may have one of its cells reaching the over-discharge state prematurely which is undetected by the electronic protection device and the LiFePO₄ cathode material of that particular cell may be permanently damaged if it reaches and exceeds its phase change voltage point under prolonged over-discharge conditions.

Furthermore, if a particular cell of a battery comprising a plurality of cells connected in series falls into an over-discharge condition, that particular cell may reverse its polarity through the continued current discharge of the other cells and either oxidize or reduce the electrolyte thereby degrading it to a point where that particular cell is permanently damaged which will affect the overall longevity and performance of the battery.

Thus, there is a need for a lithium battery based on LiFePO₄ cathode material and Li₄Ti₅O₁₂ anode material designed with a safety mechanism that prevents degradation of the battery in an over-discharge state.

### STATEMENT OF INVENTION

The present invention seeks to provide a safe large format lithium ion rechargeable battery based on LiFePO₄ cathode material and Li₄Ti₅O₁₂ anode material having a long cycle life.

In accordance with a broad aspect, the invention seeks to provide a lithium ion rechargeable battery comprising at least one electrochemical cell, each electrochemical cell comprising an anode of Li₄Ti₅O₁₂ type, a cathode of LiFePO₄ type and an electrolyte separating the anode from the cathode, wherein the electrochemical cell comprises an excess of LiFePO₄ cathode material relative to the Li₄Ti₅O₁₂ anode material to prevent permanently damaging the electrochemical cell in an over-discharge condition.

### BRIEF DESCRIPTION OF THE DRAWINGS

The invention will be better understood and other advantages will appear by means of the following description and the following drawings in which:

FIG. 1 is a diagram illustrating the discharge curves of an electrochemical cell (B1) comprising an LiFePO₄ based cathode (F1) and an Li₄Ti₅O₁₂ based anode (T1), the electrochemical cell having an excess capacity of LiFePO₄ cathode relative to the capacity of the Li₄Ti₅O₁₂ based anode, and

FIG. 2 is a schematic view of a lithium battery comprising a plurality of electrochemical cells connected in series.

### DESCRIPTION OF PREFERRED EMBODIMENT(S)

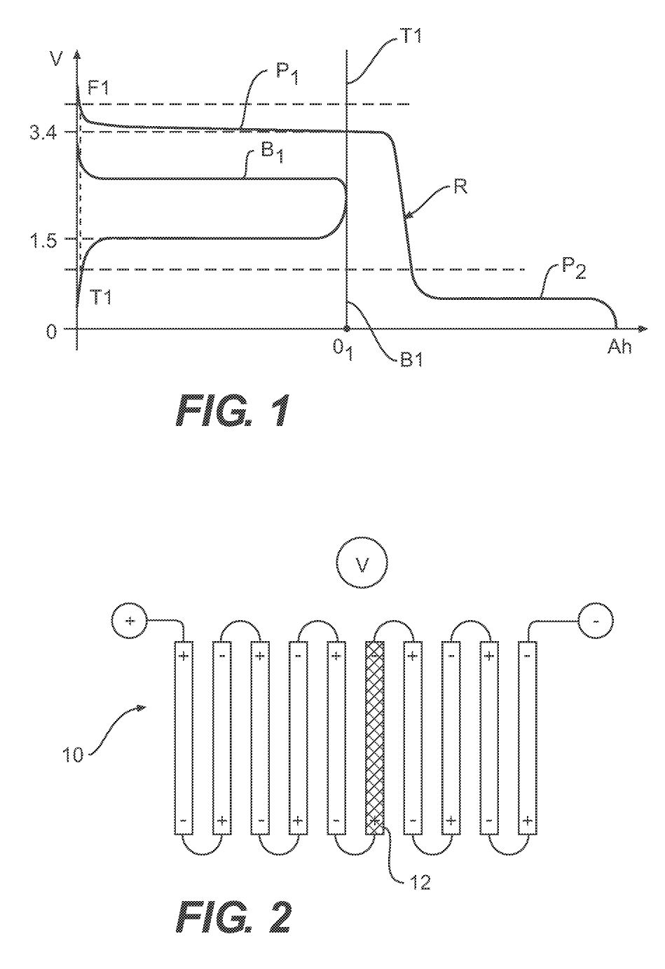

FIG. 1 illustrates the discharge behavior of an LiFePO₄ based cathode material combined to an Li₄Ti₅O₁₂ based anode material in an electrochemical cell with the theoretical voltage stability window of the electrolyte separator positioned between the LiFePO₄ cathode and the Li₄Ti₅O₁₂ anode represented in doted lines. The electrolyte separator may be a liquid or gelled soaked in a microporous separator. The electrolyte is also present in the LiFePO₄ cathode and the Li₄Ti₅O₁₂ anode. The LiFePO₄ cathode material discharge curve F1 has its plateau around 3.4 V vs Li+/Li which is below the upper limit of the stability window of the electrolyte separator used. The Li₄Ti₅O₁₂ anode material discharge curve T1 has its plateau around 1.5 V vs Li+/Li which is above the lower limit of the stability window of the electrolyte separator used. The electrochemical cell corresponding to and represented by the discharge curve B1 illustrated in FIG. 1 is designed with an excess capacity of the LiFePO₄ cathode material relative to the capacity of the Li₄Ti₅O₁₂ anode such that in over-discharge conditions, it is the oxidation of the Li₄Ti₅O₁₂ anode that will be exhausted first thereby preventing the LiFePO₄ cathode material from reaching the steep reduction slope R which is exothermic and further reaching the second plateau P2 of the LiFePO₄ cathode material that marks an irreversible phase change of the LiFePO₄ cathode material which causes permanent capacity loss of the electrochemical cell. The electrochemical cell is preferably designed with a 5% excess of LiFePO₄ cathode material relative to the Li₄Ti₅O₁₂ anode. The electrochemical cell may be designed with a 10% excess of LiFePO₄ cathode material relative to the Li₄Ti₅O₁₂ anode for added safety and even as much as 20% excess of LiFePO₄ cathode material relative to the Li₄Ti₅O₁₂ anode for increased safety.

In the electrochemical cell configuration outlined in the graph of FIG. 1, the discharge cut-off theoretically occurs when the potential difference of the electrochemical cell (B1) reaches about 0 Volt vs Li+/Li thereby maintaining the voltage at the surface of the Li₄Ti₅O₁₂ anode and at the surface of the LiFePO₄ cathode of the cell within the stability window of the electrolyte used. However when a battery 10 comprising a plurality of electrochemical cells connected in series as illustrated in FIG. 2 and the discharge cut-off voltage is determined as the sum of the voltages of the plurality of electrochemical cells, there exist the possibility that one of the electrochemical cell of the series, for example: cell 12, may reach its theoretical discharge cut-off voltage before the others and continue to be discharged while the sum of the voltages of the series of electrochemical cells remains above the overall discharge cut-off voltage thereby bringing that electrochemical cell 12 into an over-discharge condition. In this specific situation, because electrochemical cell 12 comprises an excess capacity of LiFePO₄ cathode material relative to the capacity of the Li₄Ti₅O₁₂ anode, the Li₄Ti₅O₁₂ anode will continue to oxidize until it is exhausted and its surface will eventually reach a voltage outside the stability window of the electrolyte where the solvent in the electrolyte begins to oxidize at the surface of the Li₄Ti₅O₁₂ anode whereas the LiFePO₄ cathode material remains stable on its initial discharge plateau P1. The solvent portion of the electrolyte will undergo oxidation at the surface of the Li₄Ti₅O₁₂ anode until the sum of the voltages of the series of electrochemical cells reaches the overall discharge cut-off voltage. Contrary to a typical Li-ion cells in which the anode is made of carbon or graphite having a large specific area that rapidly oxidize a large portion of the solvent contained in the electrolyte separator generating a substantial amount of heat and gas, the surface area of the Li₄Ti₅O₁₂ anode is relatively small and the solvent contained in the electrolyte oxidizes slowly thereby generating a limited amount of heat and gas and only partially degrading the electrolyte. The oxidized electrolyte having been partially degraded remains operational for further cycles, has generated limited amount of heat and gas and the LiFePO₄ cathode material has been spares from potential harmful reduction. To improve the safety aspect of a battery as illustrated schematically in FIG. 2, a simple venting system is preferably used on the casing of the battery as is well in the art which may easily manage the low pressure and temperature evolution resulting from the solvent oxidation at the surface of the Li₄Ti₅O₁₂ anode as compared to the sophisticated venting systems used in typical Li-ion cells where pressure and temperature increase rapidly and may lead to failure.

FIG. 2 illustrates schematically, an example of a battery 10 comprising a plurality of series-connected electrochemical cells each having an LiFePO₄ cathode, an Li₄Ti₅O₁₂ anode and a liquid or gelled electrolyte therebetween. In this particular example, battery 10 is monitored by a simple electronic system that shuts off the battery when its voltage V falls below 1.0 Volts or exceeds 2.0 Volts. As previously described, a cell 12 may be defective and fall below the 1.0 Volt threshold while the voltage V of battery 10 remains above the 1.0 Volt threshold. In such occurrences, the individual voltage B1 of cell 12 will fall to 0 volt and the Li₄Ti₅O₁₂ anode will oxidize until it is exhausted and the surface of the anode will reach a voltage 3.4 Volts. When the Li₄Ti₅O₁₂ anode, the cell 12 inverses its polarity. However, the excess of LiFePO₄ cathode material relative to the Li₄Ti₅O₁₂ anode material prevents the simultaneous exhaustion of the cathode material. As previously described, when cell 12 inverses its polarity and the voltage of the anode reaches a voltage point outside the stability window of the electrolyte (4.0-5.0 Volts), the solvent in the electrolyte begins to oxidize at the surface of the Li₄Ti₅O₁₂ anode. The solvent portion of the electrolyte will undergo oxidation at surface of the Li₄Ti₅O₁₂ anode until the sum of the voltages V of the series of electrochemical cells reaches the overall discharge cut-off voltage. The LiFePO₄ cathode voltage will remain on its plateau P1 (FIG. 1) until its excess is consume thereby providing an important buffer to protect itself and the cell 12 in over-discharge against potential exothermic reduction once it reaches its steep reduction slope R (FIG. 1).

The electrolyte separator of the electrochemical cell configuration outlined above may be any kind of liquid or gelled electrolytes known to those skilled in the art that comprise an alkali metal salt and a aprotic solvent and/or a polar solvent and optionally a polymer. The electrolyte may also be a dry solid polymer. The electrolyte may be polymer, copolymer or terpolymer solvating or not, optionally plasticized or gelled by a polar liquid containing at least one metallic salt in solution.

The electrolyte may also be an ionic liquid or a liquid salt having a stability window comprised between 1.0 Volts or lower and 3.7 Volts and higher.

While the invention has been described in connection with what is presently considered to be the most practical and preferred embodiments, it is to be understood that the invention is not to be limited to the disclosed embodiments and elements, but, to the contrary, is intended to cover various modifications, combinations of features, equivalent arrangements, and equivalent elements included within the spirit and scope of the appended claims. Furthermore, the dimensions of features of various components that may appear on the drawings are not meant to be limiting, and the size of the components therein can vary from the size that may be portrayed in the figures herein. Thus, it is intended that the present invention covers the modifications and variations of the invention, provided they come within the scope of the appended claims and their equivalents.

1. A lithium rechargeable battery comprising a plurality of electrochemical cells, each said electrochemical cells comprising an Li₄Ti₅O₁₂ based anode, an LiFePO₄ based cathode, an electrolyte and a separator between said anode from said cathode, wherein each said electrochemical cell comprises an excess of LiFePO₄ based cathode relative to the Li₄Ti₅O₁₂ based anode to prevent permanently damaging at least one of said plurality of electrochemical cells in an over-discharge condition.

2. A lithium rechargeable battery as defined in claim 1 wherein the electrolyte includes at least one solvent and a salt.

3. A lithium rechargeable battery as defined in claim 1 wherein the electrolyte is a liquid or gelled electrolyte comprising an aprotic solvent and an alkali metal salt.

4. A lithium rechargeable battery as defined in claim 1 wherein the electrolyte is a liquid or gelled electrolyte comprising a polar solvent and an alkali metal salt.

5. A lithium rechargeable battery as defined in claim 1 characterized in that the electrolyte is a polymer, copolymer or terpolymer, gelled by a polar liquid containing at least one metallic salt in solution.

6. A lithium rechargeable battery as defined in claim 1 characterized in that the electrolyte is a polymer, copolymer or terpolymer, solvating and containing at least one metallic salt in solution.

7. A lithium rechargeable battery as defined in claim 1 wherein the electrolyte is an ionic liquid.

8. A lithium rechargeable battery as defined in claim 1 wherein the separator is a liquid or gelled electrolyte comprising an aprotic solvent and an alkali metal salt soaked in a microporous separator.

9. A lithium rechargeable battery as defined in claim 1 wherein the separator is a polar solvent and an alkali metal salt soaked in a microporous separator.

10. A lithium rechargeable battery as defined in claim 1 wherein the separator is a polymer, copolymer or terpolymer, gelled by a polar liquid containing at least one metallic salt in solution soaked in a microporous separator.

11. A lithium rechargeable battery as defined in claim 1 wherein the separator is an ionic liquid soaked in a microporous separator.

12. A lithium rechargeable battery as defined in claim 1 wherein the excess of LiFePO₄ based cathode relative to the Li₄Ti₅O₁₂ based anode is less than 5%.

13. A lithium rechargeable battery as defined in claim 1 wherein the excess of LiFePO₄ based cathode relative to the Li₄Ti₅O₁₂ based anode is less than 10%.

14. A lithium rechargeable battery as defined in claim 1 wherein the excess of LiFePO₄ based cathode relative to the Li₄Ti₅O₁₂ based anode is less than 20%.
